(19) United States
(12) Patent Application Publication
(10) Pub. No.: US 2015/0200732 A1
(43) Pub. Date: Jul. 16, 2015

(54) TRANSCEIVERS USING RESONANT COUPLING AND NONLINEAR EFFECT BY PLASMA WAVE AND RECEIVERS USED IN INTER-CHIP OR INTRA-CHIP COMMUNICATION

(71) Applicant: KOREA ADVANCED INSTITUTE OF SCIENCE AND TECHNOLOGY, Yuseong-gu (KR)

(72) Inventors: Song Cheol Hong, Yuseong-gu (KR); Sung Mook Lim, Yuseong-gu (KR); Seung Wan Chai, Yuseong-gu (KR)

(21) Appl. No.: 14/578,989

(22) Filed: Dec. 22, 2014

(30) Foreign Application Priority Data
Jan. 10, 2014 (KR) 10-2014-0003585
Nov. 14, 2014 (KR) 10-2014-0158864

(51) Int. Cl. H04B 10/90; H05H 15/00

(52) U.S. Cl. CPC H04B 10/90; H05H 15/00

(57) ABSTRACT

A transceiver using resonant coupling and nonlinear effect by plasma wave may include a split ring resonator transmitter and a split ring resonator receiver. The split ring resonator transmitter is formed by a split ring resonator antenna that transmits a clock signal. The split ring resonator receiver receives the clock signal by a resonant coupling, and the split ring resonator receiver is separated from the split ring resonator transmitter by a first distance.

### CROSS-REFERENCE TO RELATED APPLICATION

This application claims priority under 35 USC §119 to Korean Patent Application No. 10-2014-0003585, filed on Jan. 10, 2014 and Korean Patent Application No. 10-2014-0158864, filed on Nov. 14, 2014 in the Korean Intellectual Property Office (KIPO), the contents of which are herein incorporated by reference in their entirety.

### BACKGROUND

1. Technical Field

Example embodiments relate generally to signal transmission and more particularly to transceivers using resonant coupling and nonlinear effect by plasma wave and receivers used in inter-chip or intra-chip communication.

2. Description of the Related Art

Integration rate of integrated circuits (ICs) increases and operating frequency becomes higher as semiconductor devices are miniaturized. Increase of integration rate of ICs make one chip perform more functions and enhance performance by parallel processing.

However, increase of integration rate of ICs increases routings of signal transmission lines, render the signal transmission lines thinner, and signal integrity decreases due to increased impedance.

Clock signal is greatly affected by loss in the signal transmission lines. Since the clock signal needs to be provided to all positions of chip from one portion, metal lines having great thickness are used for transmission lines that deliver clock signal. However, the loss in the signal transmission line causes delays of the clock signal.

Receiving circuits need to be disposed about various portions in a chip, and thus occupying area increases. In addition, when reducing the size of an antenna, an ultra high frequency greater than 100 GHz needs to be used, which causes great loss in the signal transmission line and signal distortion due to long interconnection.

### BRIEF SUMMARY OF THE DISCLOSURE

Some example embodiments provide a transceiver using resonant coupling and nonlinear effect by plasma wave, capable of reducing occupied area.

Some example embodiments provide a receiver used in inter-chip or intra-chip communication, capable of reducing occupied area.

According to example embodiments, a transceiver using resonant coupling and nonlinear effect by plasma wave may include a split ring resonator transmitter and a split ring resonator receiver. The split ring resonator transmitter is formed by a split ring resonator antenna that transmits a clock signal. The split ring resonator receiver receives the clock signal by a resonant coupling and the split ring resonator receiver is separated from the split ring resonator transmitter by a first distance.

In example embodiments, each of the split ring resonator transmitter and the split ring resonator receiver may be a vertical type split ring resonator formed vertically with respect to a substrate.

The transceiver may further include a plurality of split ring resonator repeaters formed between the split ring resonator transmitter and the split ring resonator receiver and the plurality of split ring resonator repeaters may be separated from the split ring resonator transmitter and the split ring resonator receiver.

In example embodiments, each of the split ring resonator transmitter and the split ring resonator receiver may be a horizontal type split ring resonator formed horizontally with respect to a substrate.

The transceiver may further include a horizontal type split ring resonator repeater. The split ring resonator transmitter and the split ring resonator receiver may be formed in a metal layer and the horizontal type split ring resonator repeater may be formed in a different layer from the metal layer.

In example embodiments, the transceiver may further include a plasma wave transistor. The plasma wave transistor may have a source coupled to a maximum voltage position of the split ring resonator receiver, and a voltage in the split ring resonator receiver may have a maximum value at the maximum voltage position.

In example embodiments, the transceiver may further include a first plasma wave transistor that has a gate coupled to a first end of a gap of the split ring resonator receiver, and a second plasma wave transistor that has a gate coupled to a second end of the gap of the split ring resonator receiver.

In example embodiments, the split ring resonator transmitter and the split ring resonator receiver may be integrated in a same chip.

According to example embodiments, a receiver used in inter-chip communication or intra-chip communication includes a receiver and an envelope detector. The receiver receives an electromagnetic wave transmitted from a transmitter. The envelope detector is directly coupled to the receiver, and the envelope detector detects an envelope of the electromagnetic wave to obtain information included in the electromagnetic wave.

In example embodiments, the antenna may include a split ring resonator and the envelope detector may include one of an operational amplifier, a schottky diode and a plasma wave transistor, which is directly coupled to the split ring resonator.

In example embodiments, the antenna may include a yagi-uda antenna and the envelope detector may include one of an operational amplifier, a schottky diode and a plasma wave transistor, which is directly coupled to the yagi-uda antenna.

In example embodiments, the antenna may include a dipole antenna and the envelope detector may include one of an operational amplifier, a schottky diode and a plasma wave transistor, which is directly coupled to the dipole antenna.

In example embodiments, the antenna may include a patch antenna and the envelope detector may include one of an operational amplifier, a schottky diode and a plasma wave transistor, which is directly coupled to the patch antenna.

Accordingly, the transceivers may increase transmission speed in a chip by transmitting a clock signal wirelessly using resonant coupling to reduce delay in the transmission line and may reduce occupied area by employing split ring resonator transmitter and receiver. The receiver may reduce occupied area by directly coupling the antenna to the envelope detector.

### BRIEF DESCRIPTION OF THE DRAWINGS

Illustrative, non-limiting example embodiments will be more clearly understood from the following detailed description taken in conjunction with the accompanying drawings.

FIG. 1A illustrates vertical type split ring resonator (SRR) antennas which are formed vertically with respect to a substrate.

FIGS. 1B and 1C illustrate respectively reflection loss characteristic and propagation loss characteristic of the vertical type SRR antennas in FIG. 1A.

FIG. 2A illustrates horizontal type SRR antennas which are formed horizontally with respect to a substrate.

FIGS. 2B and 2C illustrate respectively reflection loss characteristic and propagation loss characteristic of the horizontal type SRR antennas in FIG. 2A.

FIG. 3A is a perspective view of a vertical type SRR, FIG. 3B is a front view of the vertical type SRR and FIG. 3C is a side view of the vertical type SRR according to example embodiments.

FIG. 4 illustrates a transceiver including a vertical type SRR transmitter and a vertical type SRR receiver according to example embodiments.

FIG. 5 illustrates a transceiver further including a repeater in addition to the vertical type SRR transmitter and the vertical type SRR receiver according to example embodiments.

FIGS. 6 through 9 respectively illustrates a transceiver according to example embodiments.

FIGS. 10 through 15 respectively illustrates a transceiver according to example embodiments.

FIGS. 16 through 17B respectively illustrate transceivers according to example embodiments.

FIGS. 18 and 19 respectively illustrate transceivers according to example embodiments.

FIG. 20 is a cross-sectional view of the vertical type SRR transmitter according to example embodiments.

FIG. 21 illustrates a receiver that directly detects a signal from a SRR antenna according to example embodiments.

FIG. 22 illustrate an example of a plasma transistor in FIG. 21.

FIG. 23 illustrates a receiver used in inter-chip communication or intra-chip communication according to example embodiments.

FIGS. 24 through 26 respectively illustrate the antenna in the receiver of FIG. 23 according to example embodiments.

FIGS. 27 and 28 respectively illustrate the envelope detector in the receiver of FIG. 23 according to example embodiments.

### DETAILED DESCRIPTION OF THE DISCLOSURE

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms.

These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In various example embodiments, split ring resonators (SRR)s are used as a transmitter and a receiver, and thus, occupied area of an antenna and a transceiver may be reduced. In addition, signals may be transmitted between a transmitter and a receiver using coupling between the SRRs, and thus signals may be transmitted very rapidly because delay is reduced in view of signal transmission through metal routing. In addition, occupied volume of a receiver may be reduced by connecting a detector of a non-resonant plasma wave transistor to a SRR antenna to directly detect signals in ultra-high frequency wave.

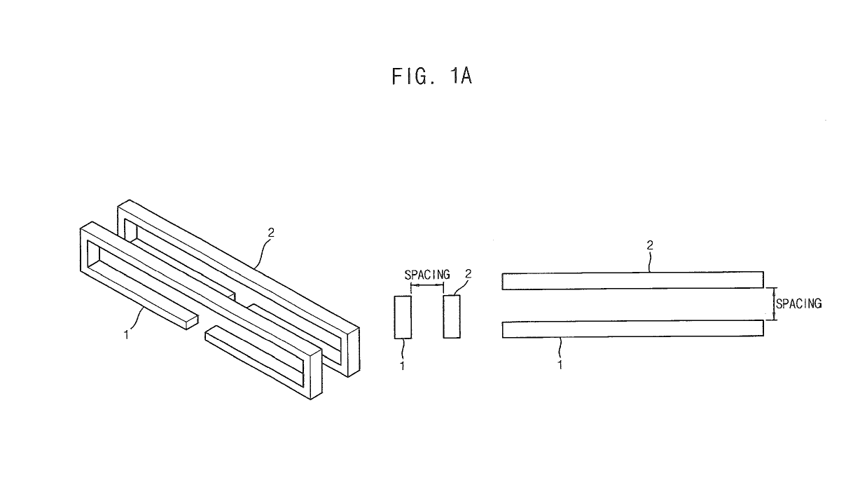

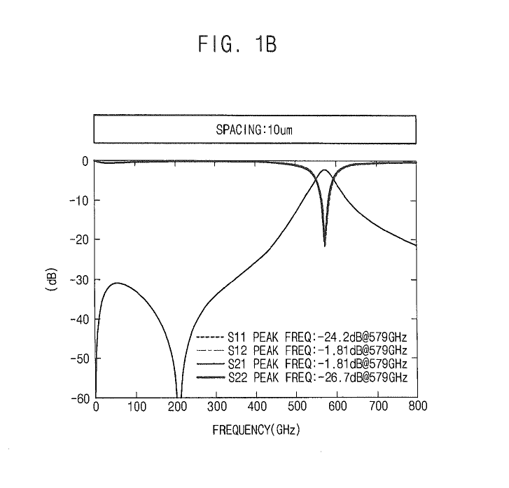

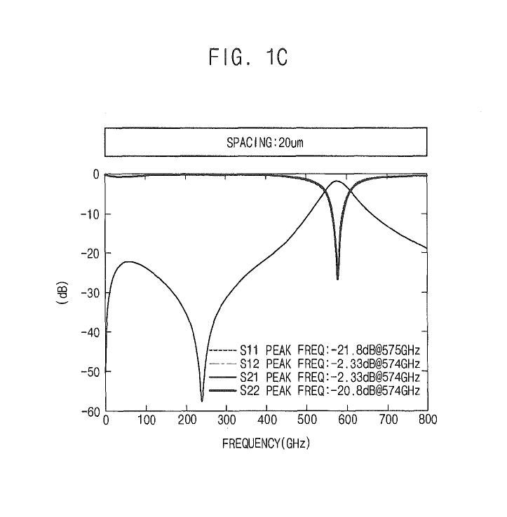

FIG. 1A illustrates vertical type SRR antennas which are formed vertically with respect to a substrate.

FIGS. 1B and 1C illustrate respectively reflection loss characteristic and propagation loss characteristic of the vertical type SRR antennas in FIG. 1A.

Referring to FIG. 1A, SRR antennas 1 and 2 are spaced apart from each other by a first distance (denoted by Spacing). The SRR antennas 1 and 2 are vertical type SRR antennas which are formed vertically with respect to a substrate.

FIG. 1B illustrates reflection loss characteristic and propagation loss characteristic of the SRR antennas 1 and 2 when the spacing corresponds to 10 um. FIG. 1C illustrates reflection loss characteristic and propagation loss characteristic of the SRR antennas 1 and 2 when the spacing corresponds to 20 um. Referring to FIGS. 1B and 1C, the reflection loss characteristic and propagation loss characteristic of the SRR antennas 1 and 2 are improved as the spacing decreases.

When a resonant frequency is low, power transfer efficiency increases because a quality factor of a resonator increases and radiation loss decreases. A size of a resonator employed in inter-chip environment or intra-chip environment needs to be much smaller than a size of a chip, a resonant frequency needs to be equal to or greater than 100 GHz. In a resonator operating with ultra-high frequency such as 100 GHz, radiation loss increases and thus, power transfer efficiency decreases accordingly. However, signal transfer characteristic is better in high frequency operating environment than in metal routing.

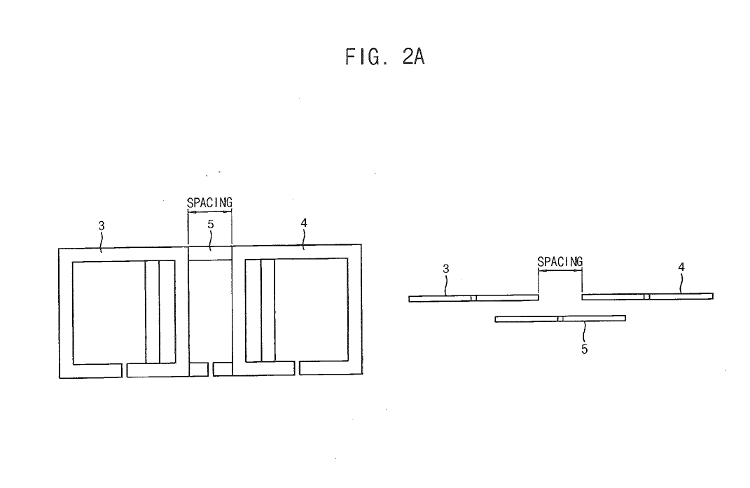

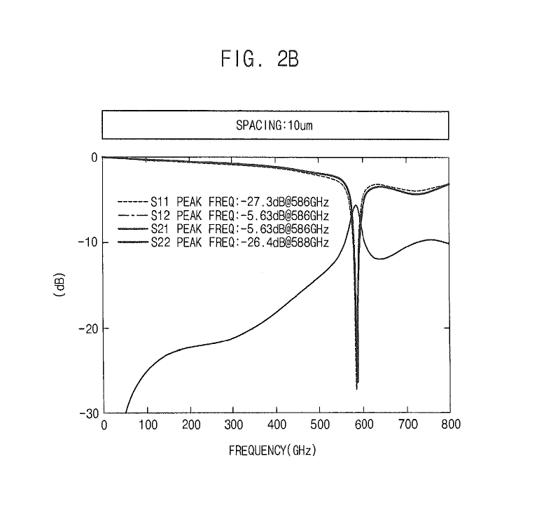

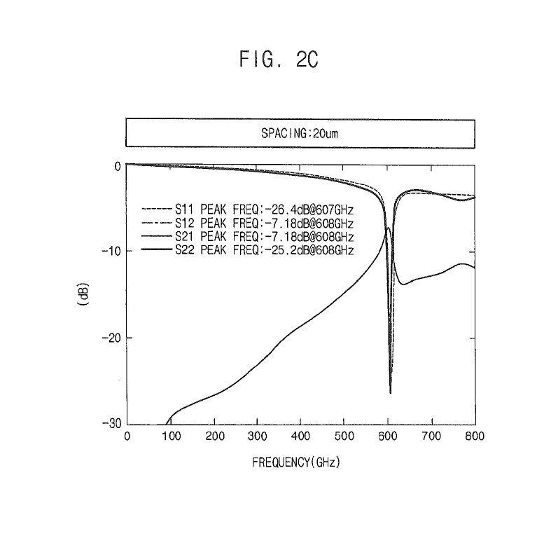

FIG. 2A illustrates horizontal type SRR antennas which are formed horizontally with respect to a substrate.

FIGS. 2B and 2C illustrate respectively reflection loss characteristic and propagation loss characteristic of the horizontal type SRR antennas in FIG. 2A.

Referring to FIG. 2A, SRR antennas 3 and 4 are spaced apart from each other by a first distance (denoted by Spacing). The SRR antennas 3 and 4 are horizontal type SRR antennas which are formed vertically with respect to a substrate. In FIG. 2A, a repeater 5 is further illustrated.

FIG. 2B illustrates reflection loss characteristic and propagation loss characteristic of the SRR antennas 3 and 4 when the spacing corresponds to 10 um. FIG. 2C illustrates reflection loss characteristic and propagation loss characteristic of the SRR antennas 3 and 4 when the spacing corresponds to 20 um. Referring to FIGS. 2B and 2C, the reflection loss characteristic and propagation loss characteristic of the SRR antennas 3 and 4 are improved as the spacing decreases.

Referring to FIGS. 1B, 1C, 2B and 2C, it is noted that the reflection loss characteristic is better in the horizontal type SRR and the propagation loss characteristic is better than the vertical type SRR.

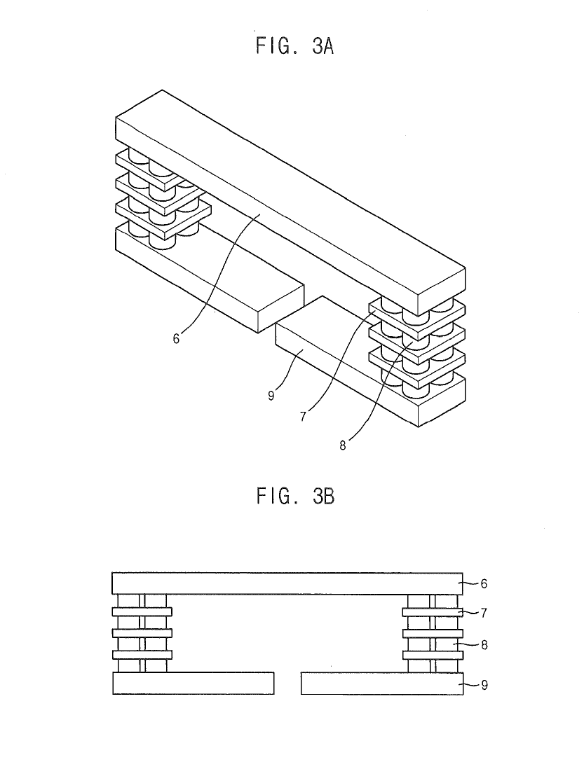

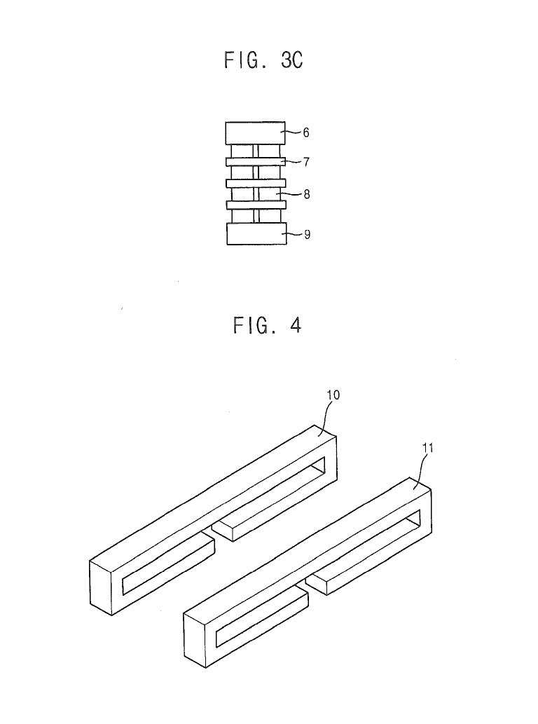

FIG. 3A is a perspective view of a vertical type SRR, FIG. 3B is a front view of the vertical type SRR and FIG. 3C is a side view of the vertical type SRR according to example embodiments.

Referring to FIGS. 3A through 3C, in the vertical type SRR, an upper metal 6 and a lower metal 9 are connected to each other by stacking at least one intermediate metal layer 7 and vias 8.

FIG. 4 illustrates a transceiver including a vertical type SRR transmitter and a vertical type SRR receiver according to example embodiments.

Referring to FIG. 4, a transceiver may include a vertical type SRR transmitter 10 and a vertical type SRR receiver 11 and each of the vertical type SRR transmitter 10 and the vertical type SRR receiver 11 may have a severed ring shape which has a gap. In the severed ring shape which has a gap, the severed ring may be modeled as an inductor whose inductance is L and the gap may be modeled as a capacitor whose capacitance is C. That is, each of the vertical type SRR transmitter 10 and the vertical type SRR receiver 11 may be modeled as an LC resonating circuit. Voltage difference in the LC resonating circuit has maximum value at a position (or a connection node) where an inductor and a capacitor are connected to each other. Therefore, a signal having maximum voltage may be received when a detector 22 is directly coupled to one end of the gap of a SRR having a severed ring shape as illustrated in FIG. 21.

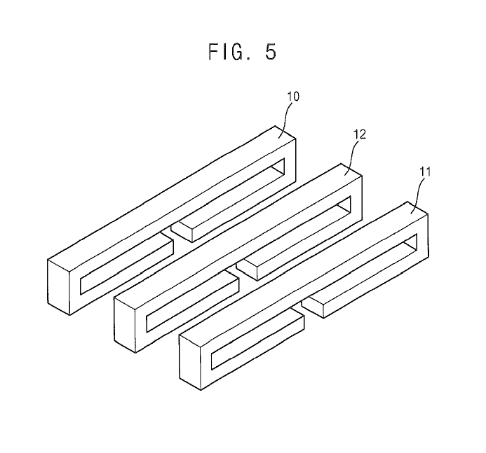

FIG. 5 illustrates a transceiver further including a repeater in addition to the vertical type SRR transmitter and the vertical type SRR receiver according to example embodiments.

Referring to FIG. 5, a transceiver may include the vertical type SRR transmitter 10, the vertical type SRR receiver 11 and a repeater 12 which is disposed between the vertical type SRR transmitter 10 and the vertical type SRR receiver 11. The repeater 12 may be also implemented with a SRR and may reduce signal loss when a distance between the vertical type SRR transmitter 10 and the vertical type SRR receiver 11 is far.

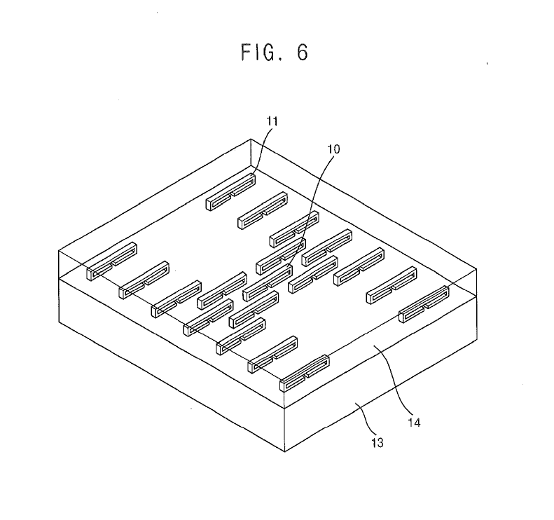

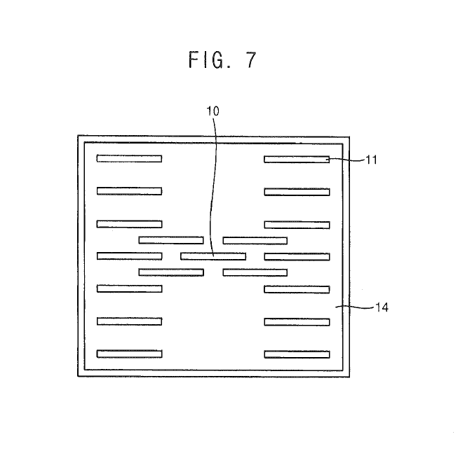

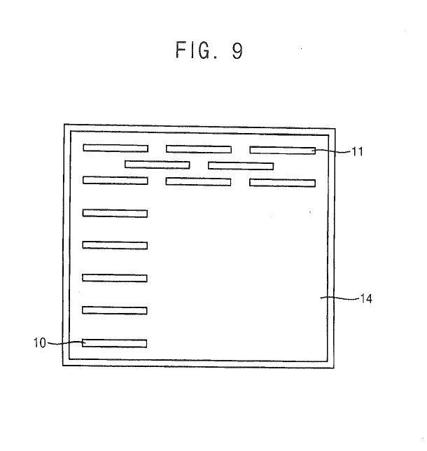

FIGS. 6 through 9 respectively illustrates a transceiver according to example embodiments.

Referring to FIGS. 6 through 9, in a transceiver, a vertical type SRR transmitter 10 and a plurality of vertical type SRR receivers 11 are formed on a dielectric layer 14 on a substrate 13. The plurality of vertical type SRR receivers 11 may transfer data to a far-positioned vertical type SRR receiver from the vertical type SRR transmitter 10 by coupling between adjacent vertical type SRR receivers 11.

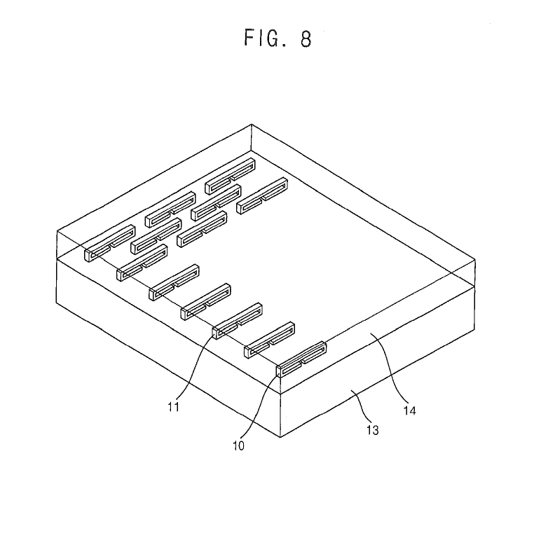

In FIG. 6, the vertical type SRR transmitter 10 is formed at a center portion of a chip and in FIG. 8, the vertical type SRR transmitter 10 is formed at an edge portion of a chip.

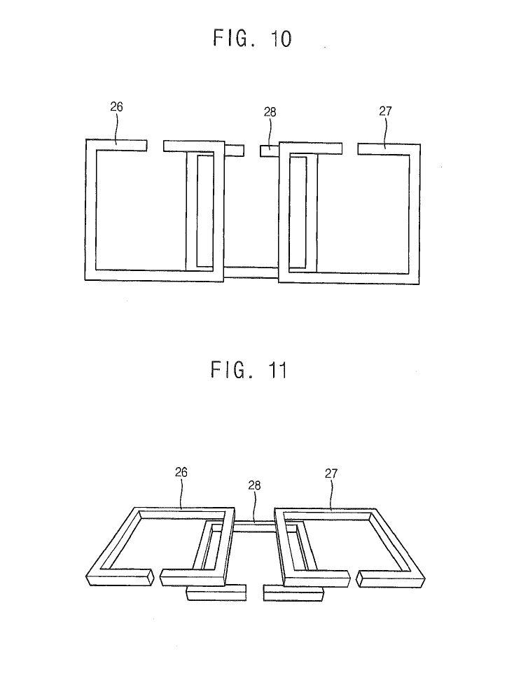

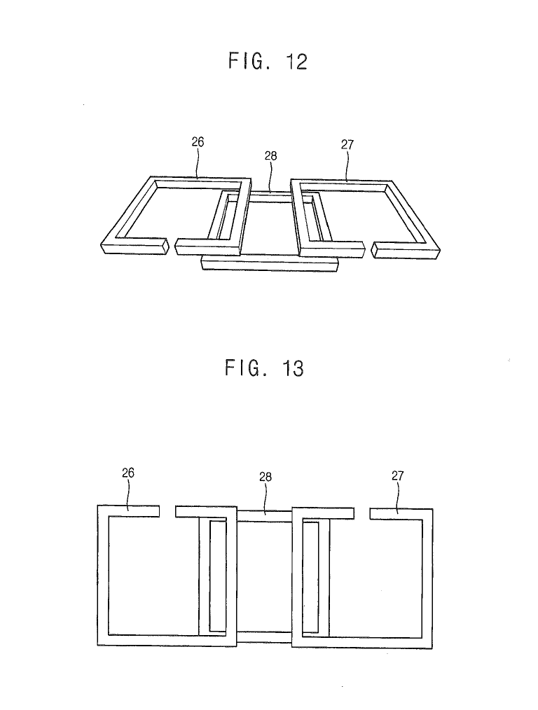

FIGS. 10 through 15 respectively illustrates a transceiver according to example embodiments.

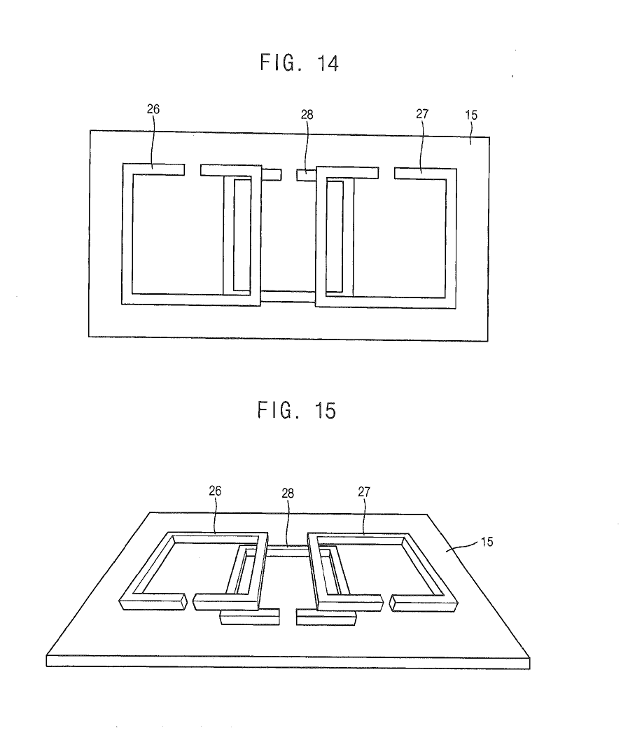

Referring to FIGS. 10 through 15, in a transceiver, a horizontal type SRR transmitter 26 and a horizontal type SRR receiver 27 are formed in a same layer and a horizontal type SRR repeater 28 is formed in another layer different from the layer where the horizontal type SRR transmitter 26 and the a horizontal type SRR receiver 27 are formed. The SRR repeater 28 in another layer may reduce signal loss between the horizontal type SRR transmitter 26 and the a horizontal type SRR receiver 27. In FIGS. 14 and 15, the SRR repeater 28 is formed on a dielectric layer 15.

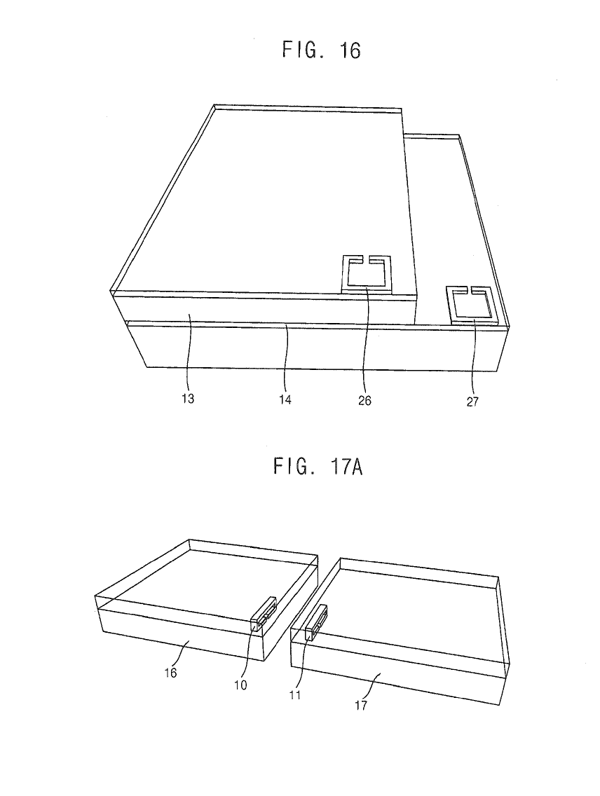

FIGS. 16 through 17B respectively illustrate transceivers according to example embodiments.

In a transceiver of FIG. 16, the horizontal type SRR transmitter 26 and the horizontal type SRR receiver 27 are formed on different substrates. In a transceiver of FIG. 17A, the vertical type SRR transmitter 10 and the vertical type SRR receiver 11 are formed in different chips 16 and 17. In a transceiver of FIG. 17B, the horizontal type SRR transmitter 26 and the horizontal type SRR receiver 27 are formed in different chips 29 and 30.

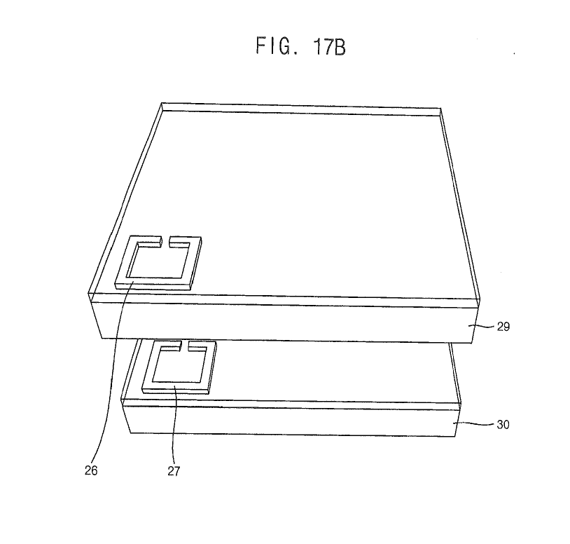

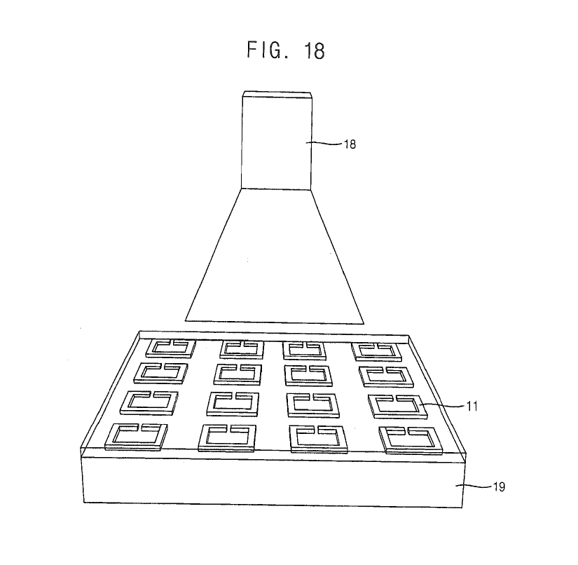

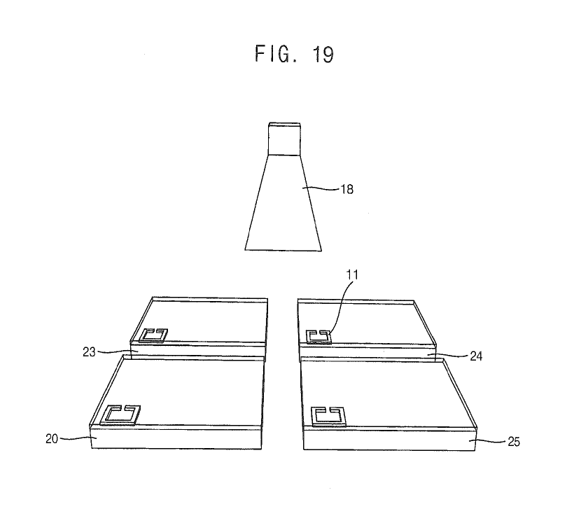

FIGS. 18 and 19 respectively illustrate transceivers according to example embodiments.

In a transceiver of FIG. 18, a plurality of horizontal type SRR receivers 11 formed in a chip 19 may receive clock signal from an external transmitter 18. In a transceiver of FIG. 19, a plurality of horizontal type SRR receivers 11 formed respectively in a plurality of chips 20, 23, 24 and 25 may receive clock signal from the external transmitter 18.

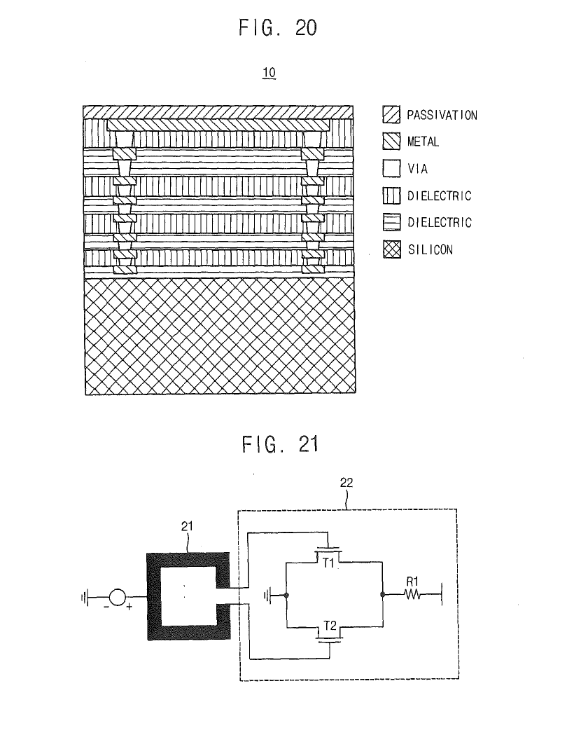

FIG. 20 is a cross-sectional view of the vertical type SRR transmitter according to example embodiments.

Referring to FIG. 20, the vertical type SRR transmitter 10 may be formed by interlaying dielectric layers and metal layers between on a silicon substrate. Passivation layer may cover a top metal layer. The top metal layer under the passivation layer may be connected to a bottom metal layer through vias.

FIG. 21 illustrates a receiver that directly detects a signal from a SRR antenna according to example embodiments.

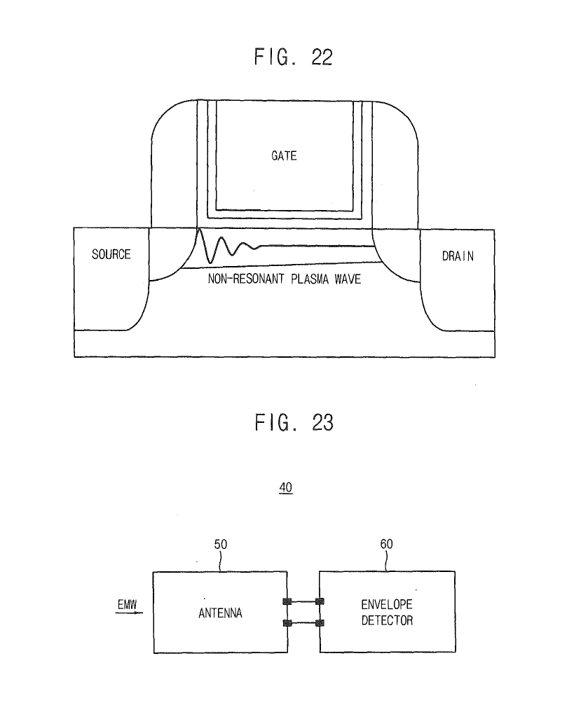

A receiver of FIG. 21 may include a SRR antenna 21 and a detector 22. The detector 22 include a first transistor T1 and a second transistor T2. Gates or sources of the first and second transistors T1 and T2 may be connected to a maximum voltage position (or an end of the gap of the SRR antenna 21. The first and second transistors T1 and T2 may be implemented with a field effect transistor (FET) which responds in a tera-hertz range. The FET may operate as a plasma wave transistor in a non-resonant mode as illustrated in FIG. 22.

When the FET operates in a high-frequency range, a plasma wave generated at a source of the FET is attenuated before reaching a drain of the FET, and charge movement occurs in a portion adjacent to the source. The FET does not respond to a carrier wave, and the portion adjacent to the source responds to an envelope of the tera hertz signal to output a DC voltage. That is, in the plasma wave transistor, charges flow from a source region to a channel region, not to a drain region. Therefore, when changes of DC voltage in the drain region occurs, which corresponds to a change of charge flow occurs, a DC signal may be detected. When a signal having a frequency higher than a cut-off frequency to the SRR antenna 21, a DC signal may be detected because channel of the FET is in non-quasi static state.

FIG. 22 illustrate an example of a plasma transistor in FIG. 21.

Referring to FIG. 22, a plasma transistor which is implemented with metal-oxide semiconductor field effect transistor (MOSFET) includes agate electrode, a source region, a drain region and a body. When a signal having a frequency of tera hertz range is applied to the gate of the MOSFET, carrier density wave propagates from the source region to the drain region. The carrier density wave attenuates in channel regions due to scattering and does not reach the drain region. Therefore, the carrier density wave has a non-linearity. Accordingly, the level of the DC voltage between the source region and the drain region increases, which is referred to as non-linear phenomenon due to plasma wave of a transistor channel. Through the non-linear phenomenon, a signal included in high-frequency carrier wave may be received as a voltage signal. The high frequency receiver may be implemented with one MOSFET. The high frequency receiver employing differential signaling may be implemented with two MOSFETs. Since the input signal has a high frequency, the size of an antenna may be reduced.

FIG. 23 illustrates a receiver used in inter-chip communication or intra-chip communication according to example embodiments.

Referring to FIG. 23, a receiver 40 used in inter-chip communication or intra-chip communication may include an antenna 50 and an envelope detector 60. The antenna 50 may receive an electromagnetic wave (EMW) from a transmitter. The envelope detector 60 is directly coupled to the antenna 50 and detects an envelope of the EMW to obtain information included in the EMW.

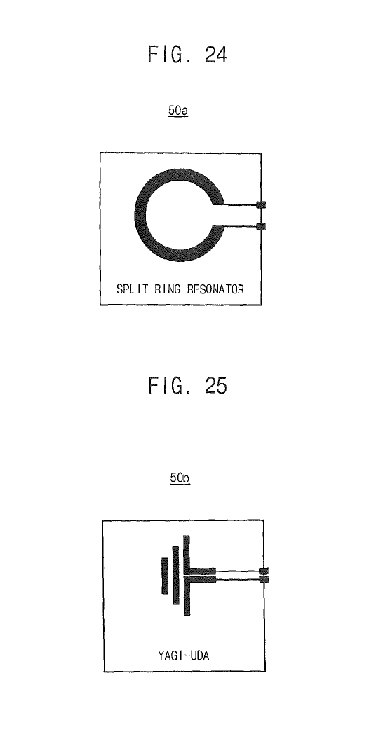

FIGS. 24 through 26 respectively illustrate the antenna in the receiver of FIG. 23 according to example embodiments.

Referring to FIG. 24, the antenna 50 in FIG. 23 may include a SRR 50a as mentioned above.

Referring to FIG. 25, the antenna 50 in FIG. 23 may include a yagi-uda antenna 50b.

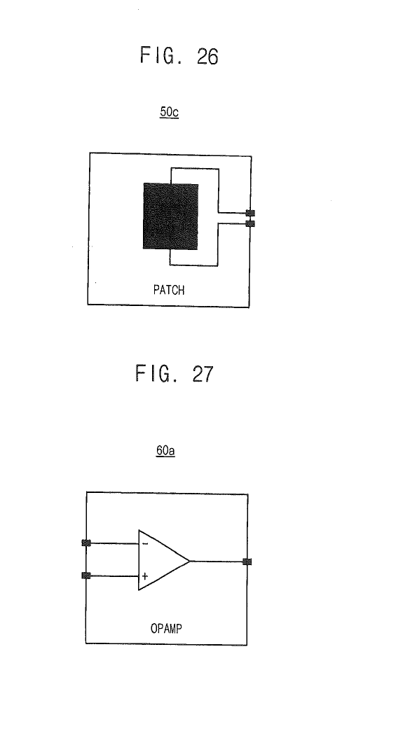

Referring to FIG. 26, the antenna 50 in FIG. 23 may include a patch antenna 50c.

Although not illustrated, the antenna 50 in FIG. 23 may include a dipole antenna.

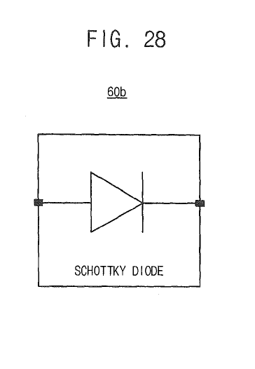

FIGS. 27 and 28 respectively illustrate the envelope detector in the receiver of FIG. 23 according to example embodiments.

Referring to FIG. 27, the envelope detector 60 in FIG. 23 may include an operational amplifier 60a.

Referring to FIG. 28, the envelope detector 60 in FIG. 23 may include a schottky diode 60b.

In addition, the envelope detector 60 in FIG. 23 may include a plasma wave transistor as mentioned above.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims.

What is claimed is:

1. A transceiver using resonant coupling and nonlinear effect by plasma wave, the transceiver comprising:
a split ring resonator transmitter formed by a split ring resonator antenna that transmits a clock signal; and
a split ring resonator receiver that receives the clock signal by a resonant coupling, the split ring resonator receiver being separated from the split ring resonator transmitter by a first distance.

2. The transceiver of claim 1, wherein each of the split ring resonator transmitter and the split ring resonator receiver is a vertical type split ring resonator formed vertically with respect to a substrate.

3. The transceiver of claim 2, further comprising:
a plurality of split ring resonator repeaters formed between the split ring resonator transmitter and the split ring resonator receiver, the plurality of split ring resonator repeaters being separated from the split ring resonator transmitter and the split ring resonator receiver.

4. The transceiver of claim 1, wherein each of the split ring resonator transmitter and the split ring resonator receiver is a horizontal type split ring resonator formed horizontally with respect to a substrate.

5. The transceiver of claim 4, further comprising:
a horizontal type split ring resonator repeater, wherein the split ring resonator transmitter and the split ring resonator receiver are formed in a metal layer and the horizontal type split ring resonator repeater is formed in a different layer from the metal layer.

6. The transceiver of claim 1, further comprising:
a plasma wave transistor that has a gate coupled to a maximum voltage position of the split ring resonator receiver, wherein a voltage in the split ring resonator receiver has a maximum value at the maximum voltage position.

7. The transceiver of claim 1, further comprising:
a plasma wave transistor that has a source coupled to a maximum voltage position of the split ring resonator receiver, wherein a voltage in the split ring resonator receiver has a maximum value at the maximum voltage position.

8. The transceiver of claim 1, further comprising:
a first plasma wave transistor that has a gate coupled to a first end of a gap of the split ring resonator receiver; and
a second plasma wave transistor that has a gate coupled to a second end of the gap of the split ring resonator receiver.

9. The transceiver of claim 1, wherein the split ring resonator transmitter and the split ring resonator receiver are integrated in a same chip.

10. A receiver used in inter-chip communication or intra-chip communication, the receiver comprising:
a receiver that receives an electromagnetic wave transmitted from a transmitter; and
an envelope detector directly coupled to the receiver, the envelope detector configured to detect an envelope of the electromagnetic wave to obtain information included in the electromagnetic wave.

11. The receiver of claim 10, wherein the antenna includes a split ring resonator and the envelope detector includes one of an operational amplifier, a schottky diode and a plasma wave transistor, which is directly coupled to the split ring resonator.

12. The receiver of claim 10, wherein the antenna includes a yagi-uda antenna and the envelope detector includes one of an operational amplifier, a schottky diode and a plasma wave transistor, which is directly coupled to the yagi-uda antenna.

13. The receiver of claim 10, wherein the antenna includes a dipole antenna and the envelope detector includes one of an operational amplifier, a schottky diode and a plasma wave transistor, which is directly coupled to the dipole antenna.

14. The receiver of claim 10, wherein the antenna includes a patch antenna and the envelope detector includes one of an operational amplifier, a schottky diode and a plasma wave transistor, which is directly coupled to the patch antenna.
